(19) United States
(12) Patent Application Publication
(10) Pub. No.: US 2026/0165536 A1
(43) Pub. Date: Jun. 18, 2026

(54) WATERPROOF SOYBEAN MILK MACHINE

(71) Applicant: Ningbo Hanchu Intelligent Technology Co., Ltd., Ningbo (CN)

(72) Inventor: Jianhua Shen, Ningbo (CN)

(21) Appl. No.: 19/026,654

(22) Filed: Jan. 17, 2025

(30) Foreign Application Priority Data
Dec. 16, 2024 (CN) 202423102122.X

(51) Int. Cl. A47J 43/08; A23C 11/10; A47J 43/046; A47J 43/07

(52) U.S. Cl. CPC A47J 43/085; A47J 43/046; A47J 43/0722; A47J 43/0727; A23C 11/103

(57) ABSTRACT

A waterproof soybean milk machine includes a cylinder; an inner tank arranged inside and coaxial with the cylinder and having a top end extending outward to form a flange; a base provided with an annular slot corresponding to the cylinder vertically and having therein a second sealing ring; a driving part arranged in the cylinder and between the base and inner tank. An annular support plate is fixed to the inner sidewall of the cylinder's top end, and provided with a first sealing ring; the flange has an outer peripheral end surface fitting the cylinder's inner sidewall and a bottom pressed and abutted against the first sealing ring; the cylinder's bottom end is inserted in the annular slot and pressed and abutted against the second sealing ring; the driving part's output shaft sealingly passes upwards through the inner tank's bottom wall and is fixed with a grinding and stirring assembly.

### CROSS REFERENCE TO RELATED APPLICATIONS

The present disclosure claims the priority to the Chinese patent application with the filing No. 202423102122.X, entitled “WATERPROOF SOYBEAN MILK MACHINE” and filed on Dec. 16, 2024 with the Chinese Patent Office, the contents of which are incorporated in the present disclosure by reference in their entirety.

### TECHNICAL FIELD

The present disclosure relates to the technical field of soybean milk machines, and more specifically to a waterproof soybean milk machine.

### BACKGROUND ART

The soybean milk machine, a small kitchen appliance for making soybean milk, may realize the fully automated processes of preheating, beating, boiling and delayed boiling, etc., which is convenient and fast. Users only need to put the soaked soybeans or other raw materials into the cup body of the soybean milk machine, add an appropriate amount of water, powering on, and selecting the corresponding function key, and then the soybean milk machine may automatically complete the soybean milk preparing process, and automatically be powered, and at the same time, may also perform heating and keep warm, so that the soybean milk can be drunk at any time.

However, the wall-breaking soybean milk machines on the market are not waterproof. When flushing, water may easily enter from the joints between the tank and the outer shell, and between the outer shell and the base. As time passes, this will pose certain safety hazards to users.

Therefore, it is a problem to be solved urgently by a person skilled in the art to provide a waterproof soybean milk machine with simple structure and reasonable design.

### SUMMARY

In view of this, an objective of the present disclosure is to provide a waterproof soybean milk machine, which solves the existing technical problems in the art that water easily enters the joint between the tank and the outer shell and the joint between the outer shell and the base to pose a safety hazard.

In order to achieve the above objective, the present disclosure adopts the following technical solutions.

A waterproof soybean milk machine includes a cylinder, an inner tank, a base and a driving part, where an annular support plate is fixed to the inner side wall at the top end of the cylinder, and a first sealing ring is provided on the annular support plate; the inner tank is arranged inside and coaxial with the cylinder, and has a top end extending outward to form a flange, and the outer peripheral end surface of the flange is attached to the inner side wall of the cylinder and the bottom of the flange is pressed and abutted against the first sealing ring; the base is provided with an annular slot corresponding to the cylinder vertically, and a second sealing ring is provided in the annular slot, and the bottom end of the cylinder is inserted in and connected to the annular slot, and pressed and abutted against the second sealing ring; the driving part is arranged inside the cylinder and correspondingly installed between the base and the inner tank, and the output shaft of the driving part passes upwards through the bottom wall of the inner tank in a sealing manner and is fixed with a grinding and stirring assembly.

Preferably, the grinding and stirring assembly includes a stirring shaft and crushing and stirring blade(s); the stirring shaft is axially arranged in the inner cavity of the inner tank, and the output shaft of the driving part passes upwards through the bottom wall of the inner tank in a sealing manner and is fixedly connected to the lower end of the stirring shaft; and multiple crushing and stirring blades are provided and all installed on the stirring shaft.

Preferably, the driving part includes a motor sleeve, a sealing plate and a driving motor; the sealing plate has a lower plate surface fixedly connected to the top end of the motor sleeve, and an upper plate surface fixedly connected to the bottom of the inner tank, and the sealing plate is provided with a through hole corresponding to the stirring shaft; the casing of the driving motor is fixed to the inner side wall of the motor sleeve, and its output shaft passes upwards through the through hole and bottom wall of the inner tank in a sealing manner and is fixedly connected to the lower end of the stirring shaft.

Preferably, the waterproof soybean milk machine further includes a sealing bushing, which is correspondingly fixed in the through hole, and the shaft body of the output shaft of the driving motor correspondingly in the through hole is tightly attached to and rotatably connected to the inner wall of the sealing bushing.

Preferably, the driving part is detachably connected to the base via connecting member(s).

Preferably, the connecting member is a threaded sleeve, and multiple threaded sleeves are provided, and are evenly distributed on the outer periphery of the inner tank and axially fixed on the outer side wall of the inner tank, and each threaded sleeve is provided therein with an internal thread; the bolt passes through the base from bottom to top and is threadedly connected to the threaded sleeve, so that the base can be detachably connected to the outer wall surface of the inner tank.

Preferably, the waterproof soybean milk machine further includes a control component, which includes a control circuit board and a touch screen; the control circuit board is fixed on the inner side wall of the cylinder, and the control circuit board is electrically connected to the driving motor; the cylinder wall of the cylinder corresponding to the control circuit board is provided with a touch screen assembly hole, and the touch screen is fixed in the touch screen assembly hole and electrically connected to the control circuit board.

Preferably, the waterproof soybean milk machine further includes a top cover, which can be buckled on the top of the inner tank, and the top cover is provided with ventilation hole(s).

Preferably, the waterproof soybean milk machine further includes a handle, wherein the handle is fixed to the upper portion of the outer side wall of the cylinder.

It can be seen from the above technical solutions that compared with the prior art, the present disclosure provides a waterproof soybean milk machine, which has the following main effects and advantages.

1. The present disclosure has a simple structure and a reasonable design, where the first sealing ring and the second sealing ring respectively seal the joint between the cylinder and the inner tank, and the joint between the cylinder and the base, enabling a good sealing and waterproof effect.

2. The sealing bushing can not only reduce the vibration and noise of the output shaft of the driving motor, but also effectively seal the gap between the output shaft of the driving motor and the through hole.

3. The output shaft of the driving motor drives the stirring shaft to rotate, so that the crushing and stirring blades can grind the soybean milk raw materials in the inner tank into powder.

4. The ventilation hole(s) on the top cover can release the hot air in the inner tank to prevent the air pressure in the inner tank from being too high.

### BRIEF DESCRIPTION OF DRAWINGS

In order to more clearly illustrate the technical solution in embodiments of the present disclosure or in the prior art, the drawings required for use in the embodiments or the description of the prior art will be briefly introduced below. Obviously, the drawings in the following description are only embodiments of the present disclosure. For a person of ordinary skill in the art, other drawings may be obtained based on the provided drawings without paying creative work.

FIG. 1 is a schematic view of an overall structure provided by the present disclosure;

FIG. 2 is an exploded view of the overall structure provided by the present disclosure;

FIG. 3 is a schematic structural view of an inner tank in the present disclosure;

FIG. 4 is a schematic structural view of a cylinder in the present disclosure;

FIG. 5 is a front view of the cylinder in the present disclosure;

FIG. 6 is a schematic sectional view taken along the A-A direction of FIG. 5 in the present disclosure;

FIG. 7 is a schematic view of connection between the driving part, the grinding and stirring assembly and the connecting members in FIG. 2 of the present disclosure;

FIG. 8 is a sectional view of the driving part in FIG. 7;

FIG. 9 is a schematic structural view of the top cover in the present disclosure;

FIG. 10 is a schematic structural view of the base in the present disclosure; and

FIG. 11 is a top view of the base in the present disclosure.

In the above: 101—first sealing ring, 102—second sealing ring, 1—cylinder, 2—inner tank, 3—base, 4—driving part, 5—grinding and stirring assembly, 6—connecting member, 7—sealing bushing, 8—control assembly, 9—top cover, 11—annular support plate, 21—flange, 31—annular slot, 41—motor sleeve, 42—sealing plate, 43—driving motor, 51—stirring shaft, 52—crushing and stirring blade, 81—control circuit board, 82—touch screen, 91—ventilation hole, 421—through hole.

### DETAILED DESCRIPTION OF EMBODIMENTS

The technical solutions in embodiments of the present disclosure will be clearly and completely described in conjunction with the drawings in the embodiments of the present disclosure. Obviously, the described embodiments are only some, not all of the embodiments of the present disclosure. Based on the embodiments of the present disclosure, all other embodiments obtained by a person of ordinary skill in the art without creative work fall within the scope of protection of the present disclosure.

In the description of the present disclosure, it should be understood that orientations or positional relationships indicated by the terms “upper”, “lower”, “front”, “back”, “left”, “right”, “vertical”, “horizontal”, “top”, “bottom”, “inner”, “outer” and the like are orientations or positional relationships shown based on the drawings, only for the convenience of describing the present disclosure and simplifying the description, and do not indicate or imply that the device or member referred to must have a specific orientation, be constructed and operated in a specific orientation, and therefore cannot be understood as a limitation on the present disclosure.

In the present disclosure, unless otherwise expressly specified or limited, the terms “install”, “connect”, “connect”, “fix” and the like should be understood in a broad sense. For example, it may be fixed connection, detachable connection, or integral connection; may be mechanical connection or electrical connection; or may be direct connection or direct connection through an intermediate medium, or may be the communication between two elements or interaction relationship between two elements. For a person of ordinary skill in the art, the specific meanings of the above terms in the present disclosure may be understood according to specific circumstances.

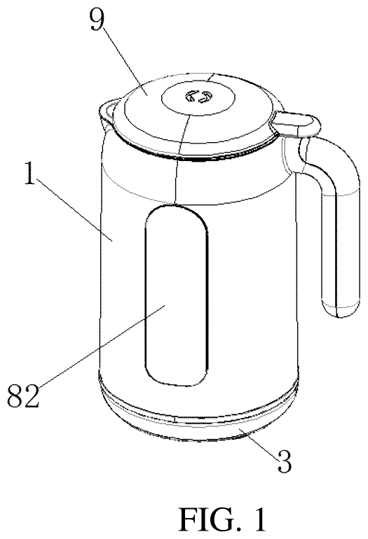

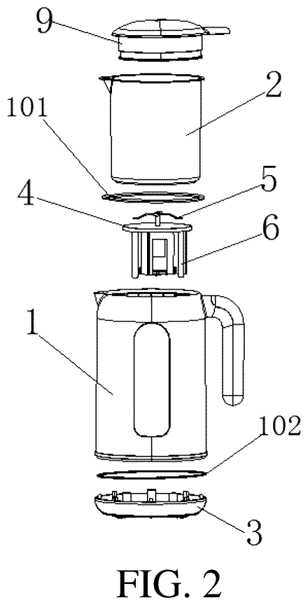

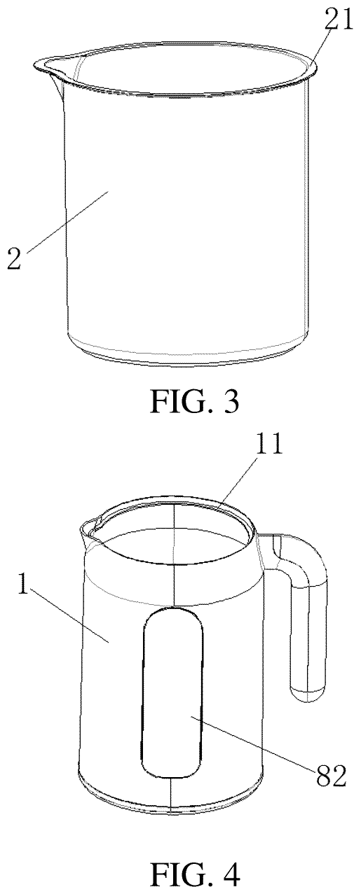

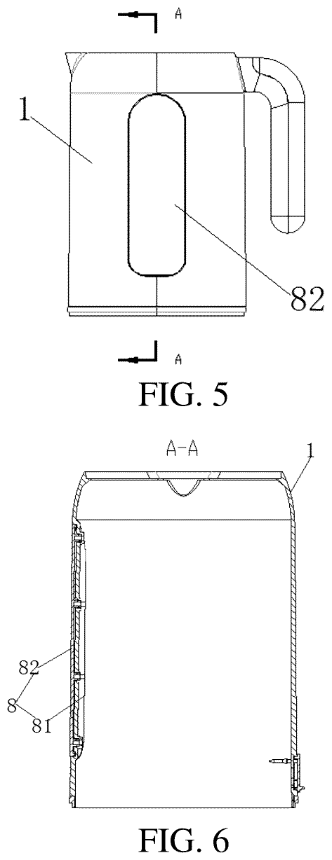

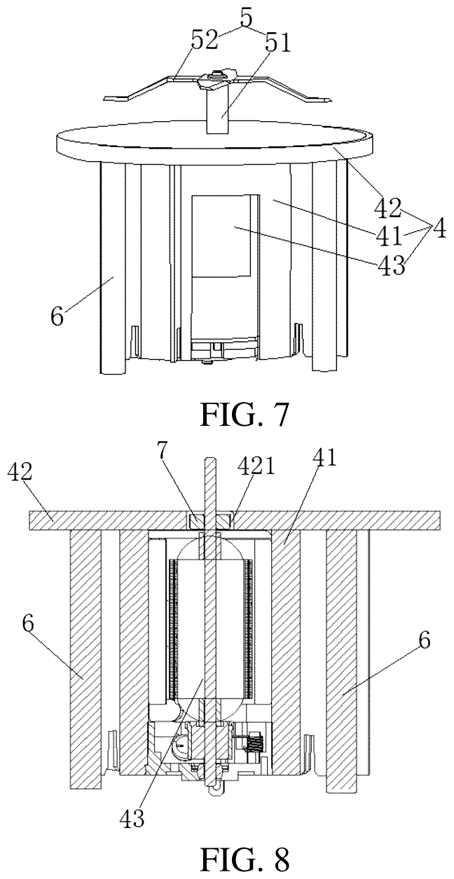

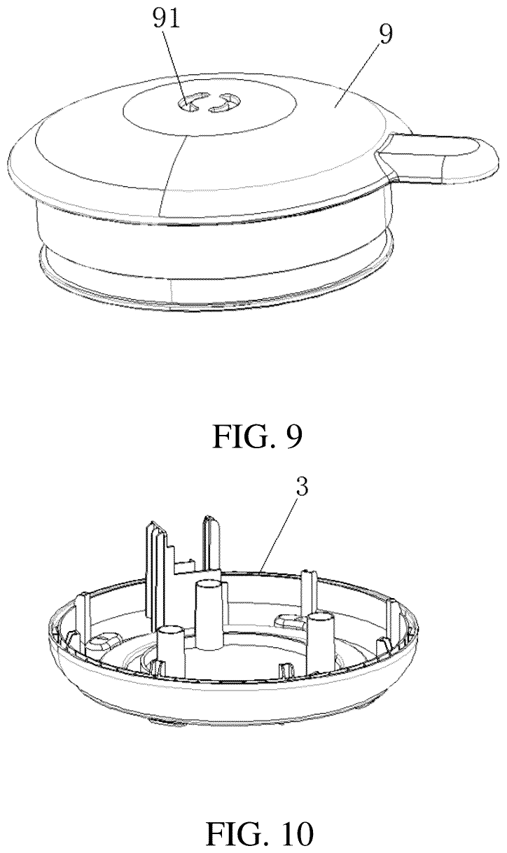

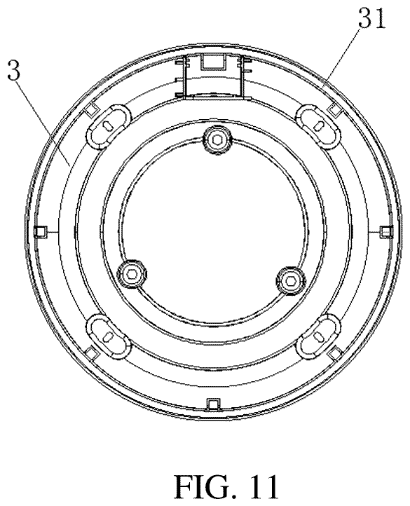

Referring to FIGS. 1 to 11, a waterproof soybean milk machine of the present disclosure includes a cylinder 1, an inner tank 2, a base 3 and a driving part 4, where an annular support plate 11 is fixed to the inner side wall of the top end of the cylinder 1, and a first sealing ring 101 is arranged on the annular support plate 11; the inner tank 2 is arranged inside and coaxial with the cylinder 1, and has a top end extending outward to form a flange 21, the outer peripheral end surface of the flange 21 is attached to the inner side wall of the cylinder 1, and the bottom of the flange is pressed and abutted against the first sealing ring 101; the base 3 is provided with an annular slot 31 corresponding to the cylinder vertically, and a second sealing ring 102 is arranged in the annular slot 31, and the bottom end of the cylinder 1 is inserted in and connected to the annular slot 31, and pressed and abutted against the second sealing ring 102; the driving part 4 is arranged inside the cylinder 1 and correspondingly installed between the base 3 and the inner tank 2, and the output shaft of the driving part passes upwards through the bottom wall of the inner tank 2 and is fixed with a grinding and stirring assembly 5.

In some embodiments, the grinding and stirring assembly 5 includes a stirring shaft 51 and crushing and stirring blade(s) 52; the stirring shaft 51 is axially arranged in the inner cavity of the inner tank 3, and the output shaft of the driving part 4 passes upwards through the bottom wall of the inner tank 2 in a sealing manner and is fixedly connected to the lower end of the stirring shaft 51; and multiple crushing and stirring blades 52 are provided and all installed on the stirring shaft 51.

In other embodiments, the driving part 4 includes a motor sleeve 41, a sealing plate 42 and a driving motor 43; the sealing plate 42 has a lower plate surface fixedly connected to the top end of the motor sleeve 41, and the upper plate surface fixedly connected to the bottom of the inner tank 2, and sealing plate 42 is provided with a through hole 421 corresponding to the stirring shaft 51; the casing of the driving motor 43 is fixed to the inner side wall of the motor sleeve 41, and its output shaft passes upwards through the through hole 421 and bottom wall of the inner tank 2 in a sealing manner and is fixedly connected to the lower end of the stirring shaft 51.

In some specific examples, the waterproof soybean milk machine further includes a sealing bushing 7, the sealing bushing 7 being correspondingly fixed in the through hole 421, and the shaft body of the output shaft of the driving motor 43 correspondingly in the through hole 421 is tightly attached to and rotatably connected to the inner wall of the sealing bushing 7.

In some embodiments, the driving part 4 is detachably connected to the base 3 via connecting member(s) 6.

In some specific examples, the connecting member 6 is a threaded sleeve. There are multiple threaded sleeves. The multiple threaded sleeves are evenly distributed on the outer periphery of the inner tank and axially fixed on its outer wall, and each threaded sleeve is provided therein with an internal thread; the bolt passes through the base 3 from bottom to top and is threadedly connected to the threaded sleeve, so that the base 3 can be detachably connected to the outer wall surface of the inner tank 2.

In other embodiments, the waterproof soybean milk machine further includes a control component 8. The control component 8 includes a control circuit board 81 and a touch screen 82; the control circuit board 81 is fixed on the inner side wall of the cylinder 1, and the control circuit board 81 is electrically connected to the driving motor 43; the cylinder wall of the cylinder 1 corresponding to the control circuit board 81 is provided with a touch screen assembly hole, and the touch screen 82 is fixed in the touch screen assembly hole and electrically connected to the control circuit board 81.

Specifically, the waterproof soybean milk machine further includes a top cover 9. The top cover 9 can be buckled on the top of the inner tank 2, and the top cover 9 is provided with ventilation hole(s) 91.

Specifically, the waterproof soybean milk machine further includes a handle, which is fixed to the upper portion of the outer side wall of the cylinder 1.

In the waterproof soybean milk machine of the present disclosure, the joint between the cylinder and the inner tank is sealed by a first sealing ring, and the joint between the cylinder and the base is sealed by a second sealing ring; a sealing bushing is used to seal the gap between the output shaft of a driving motor and the through hole of a sealing plate to prevent liquid in the inner tank from flowing into the driving motor; and the ventilation hole(s) on the top cover are used to release hot air in the inner tank and relieve the air pressure in the inner tank.

The above description of the disclosed embodiments enables those skilled in the art to implement or use the present disclosure. Various modifications to these embodiments will be apparent to those skilled in the art, and the general principles defined herein may be implemented in other embodiments without departing from the spirit or scope of the present disclosure. Therefore, the present disclosure will not be limited to the embodiments shown herein, but will conform to the widest scope consistent with the principles and novel features disclosed herein.

1. A waterproof soybean milk machine, comprising:
a cylinder, wherein an annular support plate is fixed to an inner side wall of a top end of the cylinder, and a first sealing ring is provided on the annular support plate;
an inner tank, wherein the inner tank is arranged inside and coaxial with the cylinder, and has a top end extending outward to form a flange, an outer peripheral end surface of the flange is attached to an inner side wall of the cylinder and a bottom of the flange is pressed and abutted against the first sealing ring;
a base, wherein the base is provided with an annular slot corresponding to the cylinder vertically, a second sealing ring is provided in the annular slot, and a bottom end of the cylinder is inserted in and connected to the annular slot and pressed and abutted against the second sealing ring; and
a driving part, wherein the driving part is arranged inside the cylinder and correspondingly installed between the base and the inner tank, and an output shaft of the driving part passes upwards through a bottom wall of the inner tank in a sealing manner and is fixed with a grinding and stirring assembly.

2. The waterproof soybean milk machine according to claim 1, wherein the grinding and stirring assembly comprises:
a stirring shaft, wherein the stirring shaft is axially arranged in an inner cavity of the inner tank, and the output shaft of the driving part passes upwards through the bottom wall of the inner tank in a sealing manner and is fixedly connected to a lower end of the stirring shaft; and
crushing and stirring blades, all mounted on the stirring shaft.

3. The waterproof soybean milk machine according to claim 2, wherein the driving part comprises:
a motor sleeve;
a sealing plate, wherein the sealing plate has a lower plate surface fixedly connected to a top end of the motor sleeve, and an upper plate surface fixedly connected to a bottom of the inner tank, and the sealing plate is provided with a through hole corresponding to the stirring shaft; and
a driving motor, wherein a casing of the driving motor is fixed to an inner side wall of the motor sleeve, and an output shaft of the driving motor passes upwards through the through hole and the bottom wall of the inner tank and is fixedly connected to the lower end of the stirring shaft.

4. The waterproof soybean milk machine according to claim 3, further comprising a sealing bushing, wherein the sealing bushing is correspondingly fixed in the through hole, and a shaft body of the output shaft of the driving motor correspondingly in the through hole is tightly attached to and rotatably connected to an inner wall of the sealing bushing.

5. The waterproof soybean milk machine according to claim 3, wherein the driving part is detachably connected to the base via at least one connecting member.

6. The waterproof soybean milk machine according to claim 5, wherein the at least one connecting member is each a threaded sleeve, multiple threaded sleeves are provided and are evenly distributed on an outer periphery of the inner tank and axially fixed on an outer side wall of the inner tank, and each of the threaded sleeves is provided therein with an internal thread, wherein a bolt passes through the base from bottom to top and is threadedly connected with the threaded sleeve, so that the base can be detachably connected to an outer wall surface of the inner tank.

7. The waterproof soybean milk machine according to claim 3, further comprising a control component, wherein the control component comprises:
a control circuit board, the control circuit board being fixed on the inner side wall of the cylinder, and the control circuit board being electrically connected to the driving motor; and
a touch screen, wherein a cylinder wall of the cylinder corresponding to the control circuit board is provided with a touch screen assembly hole, and the touch screen is fixed in the touch screen assembly hole and is electrically connected to the control circuit board.

8. The waterproof soybean milk machine according to claim 1, further comprising a top cover, wherein the top cover is configured to be buckled on a top of the inner tank, and the top cover is provided with at least one ventilation hole.

9. The waterproof soybean milk machine according to claim 1, further comprising a handle, wherein the handle is fixed to an upper portion of the outer side wall of the cylinder.
